(19) United States
(12) Patent Application Publication
(10) Pub. No.: US 2024/0008464 A1
(43) Pub. Date: Jan. 11, 2024

(54) CENTERLINE INTERNALLY REINFORCED FISHING SPEAR

(71) Applicant: The Headhunter Spearfishing Co., Oakland park, FL (US)

(72) Inventors: Bradley G. THORNBROUGH, Fort Lauderdale, FL (US); Luke K. MAILLIS, Long Island (BS)

(73) Assignee: The Headhunter Spearfishing Co., Oakland Park, FL (US)

(21) Appl. No.: 18/220,047

(22) Filed: Jul. 10, 2023

Related U.S. Application Data
(60) Provisional application No. 63/388,159, filed on Jul. 11, 2022.

(51) Int. Cl. A01K 81/04

(52) U.S. Cl. CPC A01K 81/04

(57) ABSTRACT

Devices, systems, and methods relating to a fishing spear and assembly thereof. In one embodiment, a fishing spear includes a fishing spear body and a centerline internal reinforcement assembly, at least a portion of the centerline internal reinforcement assembly being within the fishing spear body. In one embodiment, a method of assembling a fishing spear includes attaching a first end of a high-strength line to a nose cone at a forward end of the fishing spear device; passing one or more body tube(s) and connection element(s) over a second end of the high-strength line; coupling a rear fitting and rotatable nut to the second end of the high-strength line; and rotating the rotatable nut to apply tension to the high-strength line and to draw the nose cone and the rear fitting toward each other to provide rigidity to the fishing spear device.

### CROSS-REFERENCE TO RELATED APPLICATIONS

This Application is related to and claims priority to, or the benefit of, provisional U.S. Patent Application No. 63/388,159, filed Jul. 11, 2022, entitled CENTERLINE INTERNALLY REINFORCED FISHING SPEAR, the entirety of which is incorporated herein by reference.

### GOVERNMENT RIGHTS STATEMENT

N/A.

### TECHNICAL FIELD

The present technology is related generally to devices, systems, and methods relating to a fishing spear and assembly thereof.

### BACKGROUND

Standard pole spear fishing spears are comprised of an assembly containing a nose cone, a rear fitting, and one or more tubes or rods. If more than one tube or rod is used, there must be fittings that allow these bodies to connect. The nose cone, the rear fitting, and the connecting fittings are usually bonded to the tubes or rods with some type of adhesive or a mechanical bond such as press fit or threads. When fishing spear is fully assembled, this allows the components to act as a single body to create a fishing spear that is anywhere from two feet to 15 feet long.

However, such a configuration inherently has multiple weak points. If one of these connections or parts fails (for example, if the fishing spear breaks at one of the weak points), the speak breaks into at least two pieces and the fish will swim away with the front portion of the fishing spear while the fisherman is left with the rear portion of the spear.

### SUMMARY

Some embodiments advantageously provide devices, systems, and methods relating to a fishing spear and assembly thereof. In one embodiment, a fishing spear device includes: a fishing spear body; and a centerline internal reinforcement assembly, at least a portion of the centerline internal reinforcement assembly being within the fishing spear body.

In one aspect of the embodiment, the fishing spear body includes at least one body tube.

In one aspect of the embodiment, the centerline internal reinforcement assembly includes a high-strength line within the fishing spear body and extending between a forward end of the fishing spear device and an aft end of the fishing spear device.

In one aspect of the embodiment, the centerline internal reinforcement assembly is configured such that tensioning the high-strength line draws the forward and aft ends of the fishing spear device toward each other to provide rigidity to the fishing spear device.

In one aspect of the embodiment, the centerline internal reinforcement assembly includes: a nose cone; a rear fitting; and a rotatable nut that is rotatable within the rear fitting.

In one aspect of the embodiment, a first end of the high-strength line is coupled to the nose cone and a second end of the high-strength line is coupled to the rotatable nut, rotation of the rotatable nut applying tension to the high-strength line.

In one aspect of the embodiment, the centerline internal reinforcement assembly includes: a high-strength line; and at least one connection element.

In one aspect of the embodiment, the high-strength line passes through each of the at least one connection element and through the at least one body tube.

In one embodiment, a fishing spear device includes: a fishing spear body including a first body tube, a second body tube, and a third body tube, the second body tube being between the first body tube and the third body tube; and a centerline internal reinforcement assembly including: a high-strength line; a first connection element and a second connection element, the first connection element being between and coupled to the first body tube and the second body tube, and the second connection element being between and coupled to the second body tube and the third body tube; a nose cone, the nose cone being coupled to the first body tube; a rear fitting, the rear fitting being coupled to the third body tube; and a rotatable nut that is rotatable within the rear fitting, a first end of the high-strength line being coupled to the nose cone and a second end of the high-strength line being coupled to the rotatable nut, rotation of the rotatable nut applying tension to the high-strength line and drawing the nose cone toward the rear fitting.

In one aspect of the embodiment, the nose cone includes a forward end, an aft end, and an anchor element at the aft end, the first end of the high-strength line being coupled to the anchor element at the aft end of the nose cone.

In one aspect of the embodiment, the rotatable nut includes a forward end, an aft end, and an anchor element at the forward end, the second end of the high-strength line being coupled to the anchor element at the forward end of the rotatable nut.

In one aspect of the embodiment, each of the first connection element and the second connection element includes a flange, the flange having an outer diameter.

In one aspect of the embodiment, each of the first body tube, the second body tube, and the third body tube has an outer diameter, the outer diameter of each flange of the first connection element and the second connection element being approximately the same as the outer diameter of each of the first body tube, the second body tube, and the third body tube.

In one aspect of the embodiment, the fishing spear device further includes a spear having a spearhead, the spear being engaged with the nose cone.

In one embodiment, a method of assembling a fishing spear device includes: attaching a first end of a high-strength line to a nose cone at a forward end of the fishing spear device; passing a second end of the high-strength line through a first body tube and coupling the first body tube to the nose cone; passing the second end of the high-strength line through a connection element and coupling the connection element to the first body tube; passing the second end of the high-strength line through a second body tube and coupling the second body tube to the connection element; coupling a rear fitting to the second body tube; coupling the second end of the high-strength line to a rotatable nut; coupling the rotatable nut to the rear fitting; and rotating the rotatable nut to apply tension to the high-strength line and to draw the nose cone and the rear fitting toward each other and to compress the first body tube, the connection element, and the second body tube to provide rigidity to the fishing spear device.

In one aspect of the embodiment, the connection element is a first connection element, the method further comprising, after the step of passing the second end of the high-strength line through a second body tube and coupling the second body tube to the connection element: passing the second end of the high-strength line through a second connection element and coupling the second connection element to the second body tube; passing the second end of the high-strength line through a third body tube and coupling the third body tube to the second connection element; and not coupling the rear fitting to the second body tube, but instead coupling the rear fitting to the third body tube.

In one aspect of the embodiment, the step of rotating the rotatable nut to apply tension to the high-strength line and to draw the nose cone and the rear fitting toward each other compresses the first body tube, the first connection element, the second body tube, the second connection element, and the third body tube to provide rigidity to the fishing spear device.

In one aspect of the embodiment, the step of attaching the first end of the high-strength line to the nose cone at a forward end of the fishing spear device includes attaching the first end of the high-strength line to an anchor element at an aft end of the nose cone.

In one aspect of the embodiment, the step of coupling the second end of the high-strength line to the rotatable nut includes attaching the second end of the high-strength line to an anchor element at a forward end of the rotatable nut.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 shows a side view of an exemplary fishing spear, in accordance with the present disclosure;

FIG. 2 shows a side view of an exemplary centerline internal reinforcement assembly, configured for use in the exemplary fishing spear of FIG. 1, in accordance with the present disclosure;

FIG. 3 shows a top view of a body of the exemplary fishing spear of FIG. 1, in accordance with the present disclosure;

FIG. 4 shows a cross-sectional side view of the body of the exemplary fishing spear of FIG. 1, in accordance with the present disclosure;

FIG. 5 shows a partial cut-away view of the exemplary fishing spear of FIG. 1, in accordance with the present disclosure; and

FIG. 6 is a flowchart showing a general method of assembly of a fishing spear, in accordance with the present disclosure.

### DETAILED DESCRIPTION

Before describing in detail exemplary embodiments, it is noted that the embodiments reside primarily in combinations of apparatus components and steps related to devices, systems, and methods relating to a fishing spear and assembly thereof. Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The fishing spear of the present disclosure includes a centerline internal reinforcement assembly that provides strength to the fishing spear and, when tension is applied, keeps the components of the fishing spear securely attached to each other to form a unitary body. In one embodiment, the centerline internal reinforcement assembly (referred to herein as “CIRA”) includes a high-strength line and, optionally, one or more coupling elements. The CIRA is retained within the fishing spear body, which is composed of at least one body tube. When the fishing spear is assembled, tension applied to the high-strength line of the CIRA will draw the various components of the fishing spear toward each other. This prevents the fishing spear from separating into multiple pieces if any of the components or weak points fail while fighting a fish, which is particularly important when catching larger and more powerful fish. Consequently, fewer fish are lost. Even if the fishing spear breaks or bends, the CIRA allows the fisherman to maintain his possession of the fish. Additionally, this system allows for easy repair or replacement of individual components in the field if needed.

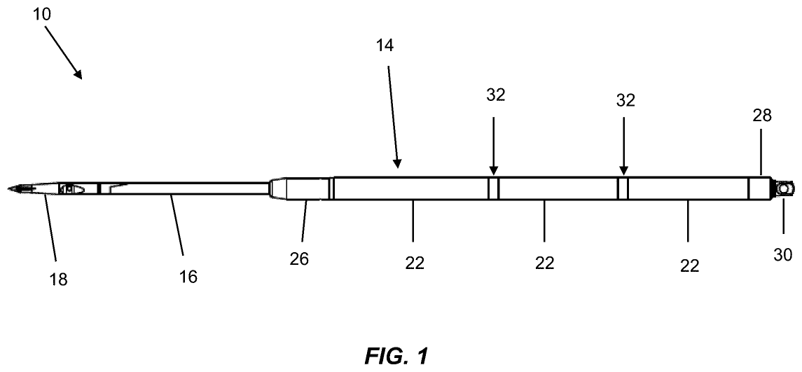

Referring now to the figures in which like reference designators are used for like elements, a side view of an exemplary fishing spear is shown in FIG. 1. In one embodiment, the fishing spear 10 generally includes a CIRA 12 and a fishing spear body 14. When the fishing spear 10 is assembled, at least a portion of the CIRA 12 is within and coaxial with the fishing spear body 14, and an elongate spear 16 with a spearhead 18 may be coupled to, at least partially received within, or otherwise engaged with a forward end of the fishing spear body 14 (for example, with a nose cone of the fishing spear 10). In one embodiment, the fishing spear body 14 includes at least one body tube 22. Each body tube 22 may be composed of carbon fiber, fiberglass, plastic, metal, and/or any other suitable material, alone or in combination. In one embodiment, the fishing spear body 14 includes one body tube 22. In another embodiment, the fishing spear body 14 includes at least two body tubes 22. In another embodiment, the fishing spear body 14 includes at least eight body tubes 22. However, it will be understood that any number of body tubes may be used.

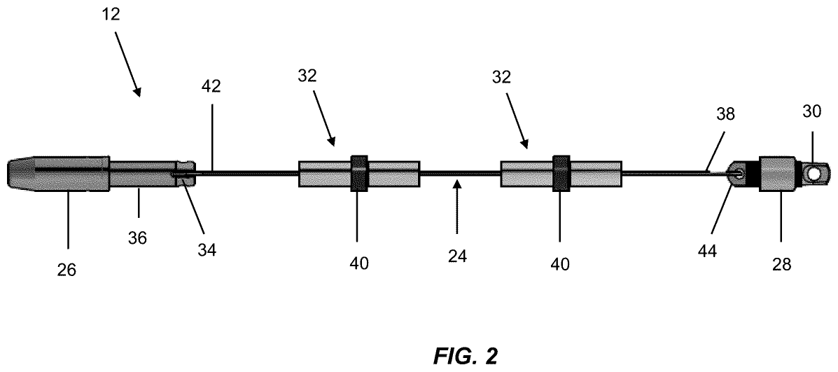

Referring now to FIG. 2, a side view of an exemplary CIRA 12 is shown. In one embodiment, the CIRA 12 generally includes a high-strength line 24, a nose cone 26, a rear fitting 28 with a rotatable nut 30, and, optionally, one or more connection elements 32. The high-strength line 24 may be a metal cable, metal wire, braided fiber, spectra cord (with or without polyester or other coating), monofilament, and/or other suitable materials, alone or in combination. The forward end 34 of the high-strength line 24 may be coupled to an aft end 36 of the nose cone 26 and the rear fitting 28 may be coupled to the aft end 38 of the high-strength line 24 such that rotation of the rotatable nut 30 is configured to draw the rear fitting 28 toward the nose cone 26 to increase tension in the high-strength line 24. Each connection element 32, the nose cone 26, and/or the rear fitting 28 may be composed of a rigid material such as stainless steel, aluminum, titanium, plastic, or other suitable material, alone or in combination. In one embodiment, each connection element 32 is a tubular, or at least substantially tubular, connection ferrule. Further, in one embodiment each connection element 32 includes a ring or flange 40 with an outer diameter that is approximately the same as or greater than each of an outer diameter of a forward end and an outer diameter of an aft end of a tubular body of the connection element. During assembly of the fishing spear 10, as discussed in greater detail below, one or more connection elements 32 and/or components of the fishing spear body 14 are strung along the high-strength line 24 between the nose cone 26 and the rear fitting 28. When the fishing spear 10 is assembled, at least a portion of the CIRA 12 is within the fishing spear body 14. Further, in some embodiments, the flanges 40 of the connection elements 32 and the body tubes 22 have approximately the same outer diameter (in one non-limiting example, within 5 mm±2 mm), such that the fishing spear body 14 has a uniform or at least substantially uniform outer diameter between a first body tube and a last body tube. In one embodiment, the high-strength line 24 is entirely within the fishing spear body 14 and at least a portion of each connection element 32 is within the fishing spear body 14.

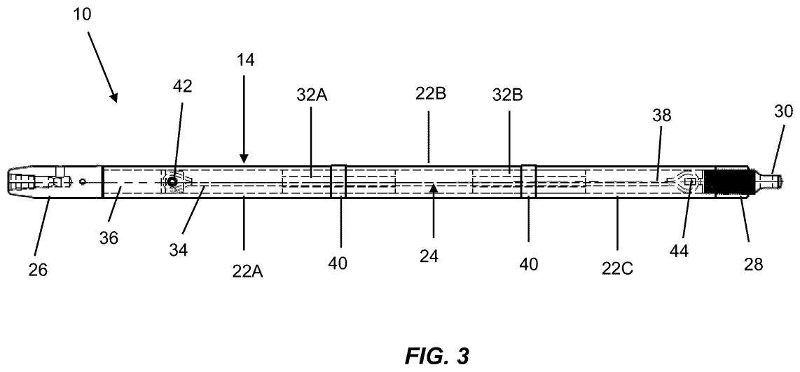

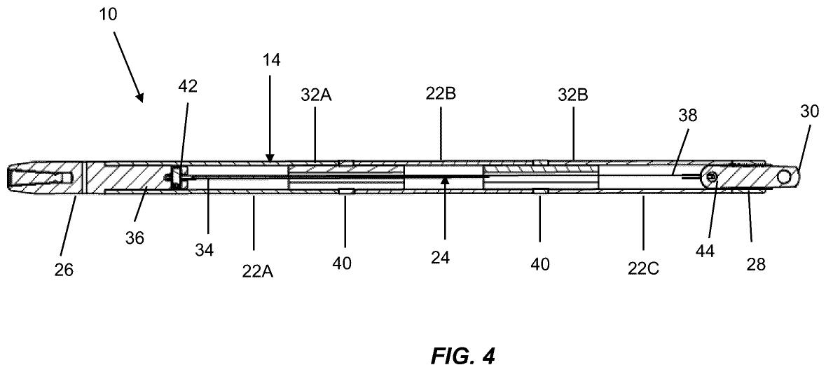

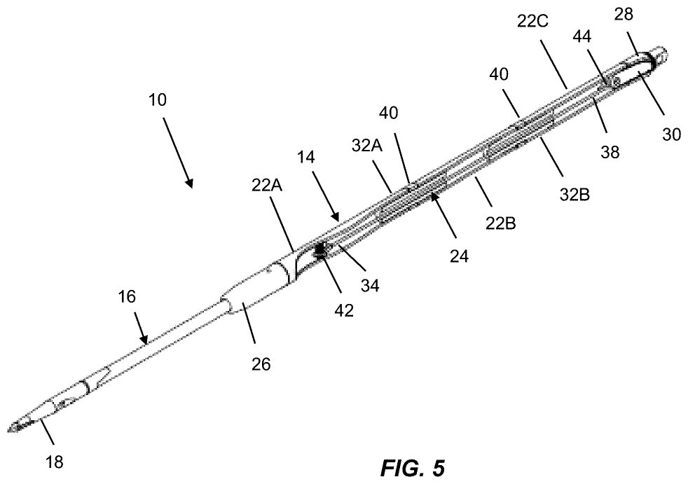

Referring now to FIGS. 3-5, various views of an assembled fishing spear are shown. In the exemplary fishing spear 10 shown in FIGS. 3-5, the fishing spear body 14 includes a first body tube 22A, a second body tube 22B, and a third body tube 22C, with the second body tube 22B being between the first and third body tubes 22A, 22C. Additionally, in the exemplary fishing spear 10 shown in FIGS. 3-5, the CIRA 12 includes a nose cone 26, a high-strength line 24, a first connection element 32A, a second connection element 32B, and a rear fitting 28 with a rotatable nut 30, with the second and third connection elements 32A, 32B being between the nose cone 26 and the rear fitting 28. In one embodiment, a first or forward end 34 of the high-strength line 24 is fixedly coupled to an aft end 36 of the nose cone 26, such as to an anchor element 42 coupled to or integrated with or within the nose cone 26 (for example, a pin, a flange, a bar, an aperture, a peg, a bolt or screw, a hook, a loop, a protrusion, or other structural element to which the high-strength line may be securely fastened). In one embodiment, a second or aft end 38 of the high-strength line 24 is fixedly coupled to the rotatable nut 30, such as to an anchor element 44 coupled to or integrated with or within the rotatable nut 30 (for example, a pin, a flange, a bar, an aperture, a peg, a bolt or screw, a hook, a loop, a protrusion, or other structural element to which the high-strength line may be securely fastened and which does not hinder rotation of the rotatable nut). The rotatable nut 30 is rotatable within the rear fitting 28, and an inner surface of the rear fitting 28 and an external surface of the rotatable nut 30 include complementary threading. Thus, rotation of the rotatable nut 30 within the rear fitting 28 draws the rotatable nut 30 through the rear fitting 28 and increases tension in the high-strength line 24 to draw the nose cone 26 toward the rear fitting 28 and, consequently, to draw the connection element(s) 32 and the body tube(s) 22 closer together to increase rigidity of the fishing spear 10 and to minimize likelihood of separation of various components during use.

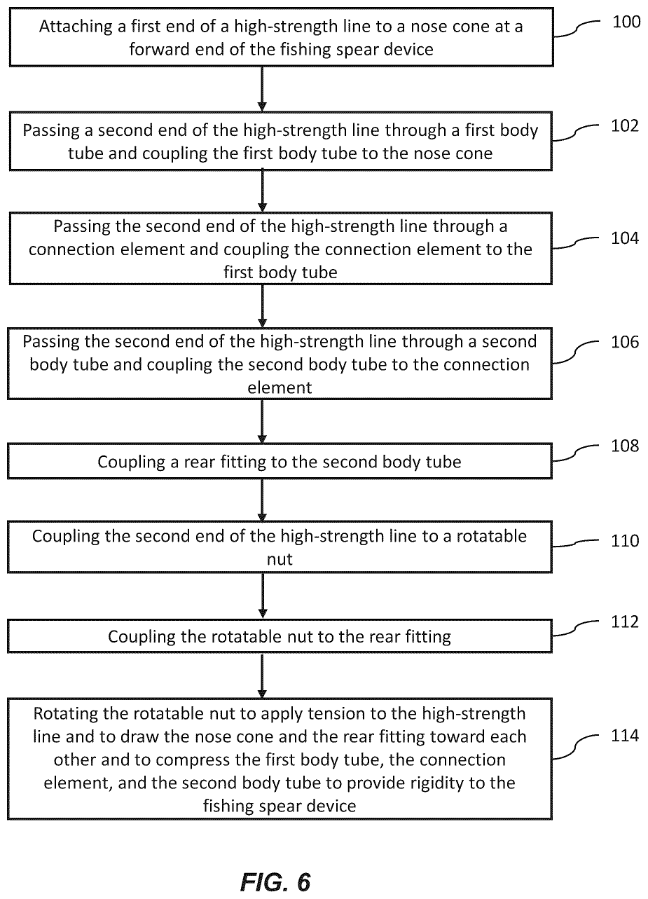

Referring now to FIG. 6, a general method of assembly of the fishing spear 10 is shown. In one embodiment of the method, the high-strength line 24 is coupled to the nose cone 26, and then remaining components of the CIRA 12 and components of the fishing spear body 14 are passed over the high-strength line 24 in an alternating fashion until all components are assembled in a configuration that is coaxial with the high-strength line 24. Put simply, the components of the fishing spear 10 are strung together along a longitudinal axis and tension is applied to the high-strength line 24 to draw the components securely together.

Continuing to refer to FIG. 6, in a first step 100 of an exemplary method of assembly, a forward end 36 of the high-strength line 24 is attached to an aft end 36 of the nose cone 26. For example, the high-strength line 24 may be secured around a post, passed through an aperture, or otherwise secured to structural feature (anchor element 42) within the nose cone 26.

Continuing to refer to FIG. 6, in a second step 102 of the exemplary method of assembly, a first body tube 22A is passed over an aft end 38 of the high-strength line 24 and toward the nose cone 26, such that the high-strength line 24 passes through the first body tube 22A. In one embodiment, the aft end 36 of the nose cone 26 has an outer diameter than is less than the inner diameter of the first body tube 22A, so that at least a portion of the aft end 36 of the nose cone 26 is received within a forward end of the first body tube 22A.

Continuing to refer to FIG. 6, in a third step 104 of the exemplary method of assembly, a first connection element 32A is passed over the aft end 38 of the high-strength line 24 (such that the high-strength line 24 passes through the first connection element 32A) and toward the first body tube 22A. In one embodiment, the forward end of the first connection element 32A has an outer diameter that is less than the inner diameter of the first body tube 22A, such that at least a portion of the forward end of the first connection element 32A is received within the aft end of the first body tube 22A. In one embodiment, the flange 40 of the first connection element 32A has approximately the same outer diameter as the first body tube 22A to act as a stop to prevent the first connection 32A element from passing too far into the first body tube 22A. In one embodiment, when the fishing spear 10 is assembled, an outer surface of each flange 40 is the only portion of each connection element 32 that is not within the fishing spear body 14.

Continuing to refer to FIG. 6, in a fourth step 106 of the exemplary method of assembly, a second body tube 22B is passed over the aft end 38 of the high-strength line 24 (such that the high-strength line 24 passes through the second body tube 22B) and toward the first connection element 32A. In one embodiment, the aft end of the first connection element 32A has an outer diameter than is less than the inner diameter of the second body tube 22B, so that at least a portion of the aft end of the first connection 32A element is received within a forward end of the second body tube 22B. In one embodiment, the flange 40 of the first connection element 32A has approximately the same outer diameter as the second body tube 22B to act as a stop to prevent the first connection element 32A from passing too far into the second body tube 22B.

Continuing to refer to FIG. 6, in a fifth step 108 of the exemplary method of assembly, a second connection element 32B is passed over the aft end 38 of the high-strength line 24 (such that the high-strength line 24 passes through the second connection element 32B) and toward the second body tube 22B. In one embodiment, the forward end of the second connection element 32B has an outer diameter that is less than the inner diameter of the second body tube 22B, such that at least a portion of the forward end of the second connection element 32B is received within the aft end of the second body tube 22B. In one embodiment, the flange 40 of the second connection element 32B has approximately the same outer diameter as the second body tube 22B to act as a stop to prevent the second connection element 32B from passing too far into the second body tube 22B.

Continuing to refer to FIG. 6, in a sixth step 110 of the exemplary method of assembly, a third body tube 22C is passed over the aft end 38 of the high-strength line 24 (such that the high-strength line 24 passes through the third body tube 22C) and toward the second connection element 32B. In one embodiment, the aft end of the second connection element 32B has an outer diameter than is less than the inner diameter of the third body tube 22C, so that at least a portion of the aft end of the second connection element 32B is received within a forward end of the third body tube 22C. In one embodiment, the flange 40 of the second connection element 32B has approximately the same outer diameter as the third body tube 22C to act as a stop to prevent the second connection element 32B from passing too far into the third body tube 22C.

It will be understood that the fifth step 108 and the sixth step 110 are optional, and may be performed when the fishing spear body 14 includes more than two body tubes 22 and more than one connection element 32. Additionally, as noted above, the fishing spear body 14 may include any number of body tubes and connection elements; therefore, in such configurations the fifth step 108 and sixth step 110 may be performed as many times as needed to couple all of the body tubes and connection elements together in an alternating arrangement.

Continuing to refer to FIG. 6, in a seventh step 112 of the exemplary method of assembly, the rotatable nut 30 (for example, the anchor element 44 of the rotatable nut) is then coupled to the aft end 38 of the high-strength line 24 and the rear fitting 28 is screwed onto and over the rotatable nut 30 and coupled to the aft end of the third body tube 22C (or to the aftmost body tube, in configurations wherein more or fewer than three body tubes are used). In other embodiments, the rotatable nut 30 and the rear fitting 28 are integrated with or coupled to each other.

Continuing to refer to FIG. 6, in an eighth step 114 of the exemplary method of assembly, rotatable nut 30 is rotated within the rear fitting 28 to apply tension to the high-strength line 24 of the CIRA 12. The more the rotatable nut 30 is tightened on the rear fitting 28, the more tension is applied. Tension may continue to be applied until the fishing spear 10 is satisfactorily rigid and strong. Lastly, an elastic band may be attached to the fishing spear 10 (for example, to the aft end of the rotatable nut and/or rear fitting) to engage a spear 16 to shoot at a fish or other target.

As discussed above, it will be understood that any number of body tubes and connection elements may be used, including in configurations wherein no connection elements are used and a single body tube is positioned between the nose cone and the rear fitting. Regardless of the number of body tubes and/or connection elements used, the fishing spear may be assembled in a forward-to-aft method, with the high-tension line being first attached to the nose cone and the rear fitting being finally attached to the last body tube.

### Embodiments

Some embodiments advantageously provide a fishing spear device including: a fishing spear body; and a centerline internal reinforcement assembly, at least a portion of the centerline internal reinforcement assembly being within the fishing spear body.

Some embodiments advantageously provide a fishing spear including: a fishing spear body including a first body tube, a second body tube, and a third body tube; and a centerline internal reinforcement assembly including: a high-strength line; a first connection element and a second connection element, the first connection element being between and coupled to the first body tube and the second body tube, and the second connection element being between and coupled to the second body tube and the third body tube; a nose cone, the nose cone being coupled to the first body tube; a rear fitting, the rear fitting being coupled to the third body tube; and a rotatable nut that is rotatable within the rear fitting, a first end of the high-strength line being coupled to the nose cone and a second end of the high-strength line being coupled to the rotatable nut, rotation of the rotatable nut applying tension to the high-strength line and drawing the nose cone toward the rear fitting.

Some embodiments advantageously provide a method of assembling a fishing spear device, the method including: attaching a first end of a high-strength line to a nose cone at a forward end of the fishing spear device; passing a second end of the high-strength line through a first body tube and coupling the first body tube to the nose cone; passing the second end of the high-strength line through a connection element and coupling the connection element to the first body tube; passing the second end of the high-strength line through a second body tube and coupling the second body tube to the connection element; coupling a rear fitting to the second body tube; coupling the second end of the high-strength line to a rotatable nut; coupling the rotatable nut to the rear fitting; and rotating the rotatable nut to apply tension to the high-strength line and to draw the nose cone and the rear fitting toward each other and to compress the first body tube, the connection element, and the second body tube to provide rigidity to the fishing spear device.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention.

What is claimed is:

1. A fishing spear device, comprising:
a fishing spear body; and
a centerline internal reinforcement assembly, at least a portion of the centerline internal reinforcement assembly being within the fishing spear body.

2. The fishing spear device of claim 1, wherein the fishing spear body includes at least one body tube.

3. The fishing spear device of claim 1, wherein the centerline internal reinforcement assembly includes a high-strength line within the fishing spear body and extending between a forward end of the fishing spear device and an aft end of the fishing spear device.

4. The fishing spear device of claim 3, wherein the centerline internal reinforcement assembly is configured such that tensioning the high-strength line draws the forward and aft ends of the fishing spear device toward each other to provide rigidity to the fishing spear device.

5. The fishing spear device of claim 4, wherein the centerline internal reinforcement assembly includes:
a nose cone;
a rear fitting; and
a rotatable nut that is rotatable within the rear fitting.

6. The fishing spear device of claim 5, wherein a first end of the high-strength line is coupled to the nose cone and a second end of the high-strength line is coupled to the rotatable nut, rotation of the rotatable nut applying tension to the high-strength line.

7. The fishing spear device of claim 2, wherein the centerline internal reinforcement assembly includes:
a high-strength line; and
at least one connection element.

8. The fishing spear device of claim 7, wherein the high-strength line passes through each of the at least one connection element and through the at least one body tube.

9. A fishing spear device comprising:
a fishing spear body including a first body tube, a second body tube, and a third body tube, the second body tube being between the first body tube and the third body tube; and
a centerline internal reinforcement assembly including:
a high-strength line;
a first connection element and a second connection element, the first connection element being between and coupled to the first body tube and the second body tube, and the second connection element being between and coupled to the second body tube and the third body tube;
a nose cone, the nose cone being coupled to the first body tube;
a rear fitting, the rear fitting being coupled to the third body tube; and
a rotatable nut that is rotatable within the rear fitting, a first end of the high-strength line being coupled to the nose cone and a second end of the high-strength line being coupled to the rotatable nut, rotation of the rotatable nut applying tension to the high-strength line and drawing the nose cone toward the rear fitting.

10. The fishing spear device of claim 9, wherein the nose cone includes a forward end, an aft end, and an anchor element at the aft end, the first end of the high-strength line being coupled to the anchor element at the aft end of the nose cone.

11. The fishing spear device of claim 9, wherein the rotatable nut includes a forward end, an aft end, and an anchor element at the forward end, the second end of the high-strength line being coupled to the anchor element at the forward end of the rotatable nut.

12. The fishing spear device of claim 9, wherein each of the first connection element and the second connection element includes a flange, the flange having an outer diameter.

13. The fishing spear device of claim 12, wherein each of the first body tube, the second body tube, and the third body tube has an outer diameter, the outer diameter of each flange of the first connection element and the second connection element being approximately the same as the outer diameter of each of the first body tube, the second body tube, and the third body tube.

14. The fishing spear device of claim 9, further comprising a spear having a spearhead, the spear being engaged with the nose cone.

15. A method of assembling a fishing spear device, the method comprising:
attaching a first end of a high-strength line to a nose cone at a forward end of the fishing spear device;
passing a second end of the high-strength line through a first body tube and coupling the first body tube to the nose cone;
passing the second end of the high-strength line through a connection element and coupling the connection element to the first body tube;
passing the second end of the high-strength line through a second body tube and coupling the second body tube to the connection element;
coupling a rear fitting to the second body tube;
coupling the second end of the high-strength line to a rotatable nut;
coupling the rotatable nut to the rear fitting; and
rotating the rotatable nut to apply tension to the high-strength line and to draw the nose cone and the rear fitting toward each other and to compress the first body tube, the connection element, and the second body tube to provide rigidity to the fishing spear device.

16. The method of assembling a fishing spear device of claim 15, wherein the connection element is a first connection element, the method further comprising, after the step of passing the second end of the high-strength line through a second body tube and coupling the second body tube to the connection element:
passing the second end of the high-strength line through a second connection element and coupling the second connection element to the second body tube;
passing the second end of the high-strength line through a third body tube and coupling the third body tube to the second connection element; and
not coupling the rear fitting to the second body tube, but instead coupling the rear fitting to the third body tube.

17. The method of assembling a fishing spear device of claim 16, wherein the step of rotating the rotatable nut to apply tension to the high-strength line and to draw the nose cone and the rear fitting toward each other compresses the first body tube, the first connection element, the second body tube, the second connection element, and the third body tube to provide rigidity to the fishing spear device.

18. The method of assembling the fishing spear device of claim 15, wherein the step of attaching the first end of the high-strength line to the nose cone at a forward end of the fishing spear device includes attaching the first end of the high-strength line to an anchor element at an aft end of the nose cone.

19. The method of assembling the fishing spear device of claim 15, wherein the step of coupling the second end of the high-strength line to the rotatable nut includes attaching the second end of the high-strength line to an anchor element at a forward end of the rotatable nut.
